(19) United States
(12) Patent Application Publication
(10) Pub. No.: US 2023/0366976 A1
(43) Pub. Date: Nov. 16, 2023

(54) ANGLE OF ARRIVAL AND ANGLE OF DEPARTURE SYSTEM OPTIMIZATION BY USING ANTENNA INFORMATION

(71) Applicant: QUALCOMM Incorporated, San Diego, CA (US)

(72) Inventors: Alexandros MANOLAKOS, Escondido, CA (US); Xiaoxin ZHANG, Sunnyvale, CA (US); Peyman SIYARI, San Jose, CA (US); Bala RAMASAMY, San Marcos, CA (US)

(21) Appl. No.: 18/246,660

(22) PCT Filed: Oct. 4, 2021
(86) PCT No.: PCT/US2021/071705

§ 371 Date: Mar. 24, 2023

(30) Foreign Application Priority Data
Oct. 14, 2020 (GR) 20200100620

(51) Int. Cl. G01S 5/08; G01S 5/00; G01S 5/02

(52) U.S. Cl. CPC G01S 5/08; G01S 5/0018; G01S 5/0236

(57) ABSTRACT

Disclosed are various techniques for wireless positioning. In an aspect, a user equipment (UE) determines one or more angle-based measurements of one or more reference signal resources transmitted by or received at the UE on one or more antennas of the UE and reports, to a positioning entity, the one or more angle-based measurements, a beam pattern associated with the one or more reference signal resources, a type of the one or more antennas, locations of the one or more antennas on the UE, an orientation of the one or more antennas, or any combination thereof.

### CROSS-REFERENCE TO RELATED APPLICATIONS

The present application for patent claims priority to Greek Patent Application No. 20200100620, entitled “ANGLE OF ARRIVAL AND ANGLE OF DEPARTURE SYSTEM OPTIMIZATION BY USING ANTENNA INFORMATION,” filed Oct. 14, 2020, and International Patent Application No. PCT/US2021/071705, entitled “ANGLE OF ARRIVAL AND ANGLE OF DEPARTURE SYSTEM OPTIMIZATION BY USING ANTENNA INFORMATION”, filed Oct. 4, 2021, both of which are assigned to the assignee hereof and expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication positioning by a user equipment (UE) includes determining one or more angle-based measurements of one or more reference signal resources transmitted by or received at the UE on one or more antennas of the UE; and reporting, to a positioning entity, the one or more angle-based measurements, a beam pattern associated with the one or more reference signal resources, a type of the one or more antennas, locations of the one or more antennas on the UE, an orientation of the one or more antennas, or any combination thereof.

In an aspect, a user equipment (UE) includes a memory; at least one transceiver; and at least one processor communicatively coupled to the memory and the at least one transceiver, the at least one processor configured to: determine one or more angle-based measurements of one or more reference signal resources transmitted by or received at the UE on one or more antennas of the UE; and report, via the at least one transceiver, to a positioning entity, the one or more angle-based measurements, a beam pattern associated with the one or more reference signal resources, a type of the one or more antennas, locations of the one or more antennas on the UE, an orientation of the one or more antennas, or any combination thereof.

In an aspect, a user equipment (UE) includes means for determining one or more angle-based measurements of one or more reference signal resources transmitted by or received at the UE on one or more antennas of the UE; and means for reporting, to a positioning entity, the one or more angle-based measurements, a beam pattern associated with the one or more reference signal resources, a type of the one or more antennas, locations of the one or more antennas on the UE, an orientation of the one or more antennas, or any combination thereof.

In an aspect, a non-transitory computer-readable medium storing computer-executable instructions that, when executed by a user equipment (UE), cause the UE to: determine one or more angle-based measurements of one or more reference signal resources transmitted by or received at the UE on one or more antennas of the UE; and report, to a positioning entity, the one or more angle-based measurements, a beam pattern associated with the one or more reference signal resources, a type of the one or more antennas, locations of the one or more antennas on the UE, an orientation of the one or more antennas, or any combination thereof.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example base station in communication with an example UE, according to aspects of the disclosure.

FIG. 5 illustrates an example format of an antenna placement and calibration information element (IE) that a device may report for angle-based positioning purposes.

FIG. 6 illustrates an example Long-Term Evolution (LTE) positioning protocol (LPP) call flow between a UE and a location server for performing positioning operations.

FIG. 7 illustrates the definition of a coordinate system by the x, y, z axes, the spherical angles, and the spherical unit vectors, according to aspects of the disclosure.

FIG. 8A illustrates the sequence of rotations that relate a global coordinate system (GCS) and a local coordinate system (LCS), according to aspects of the disclosure.

FIG. 8B illustrates the definition of spherical coordinates and unit vectors in both the GCS and LCS, according to aspects of the disclosure.

FIG. 9 illustrates an example method of wireless positioning, according to various aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

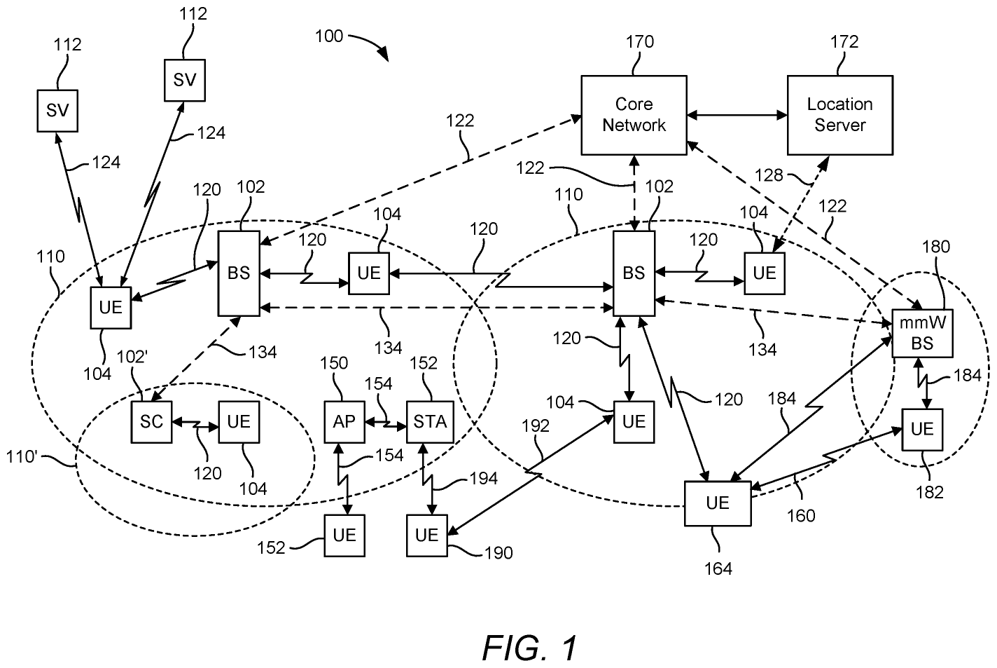

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more S Cells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

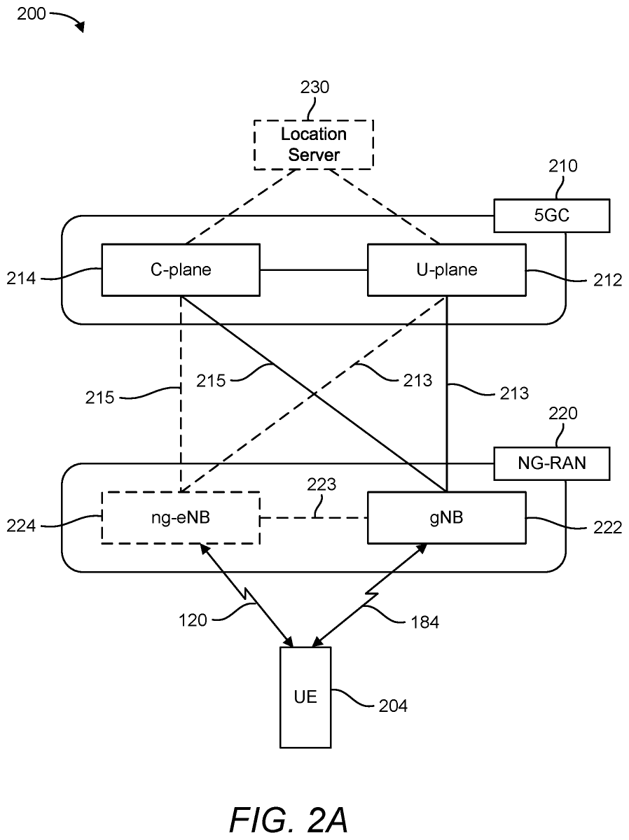

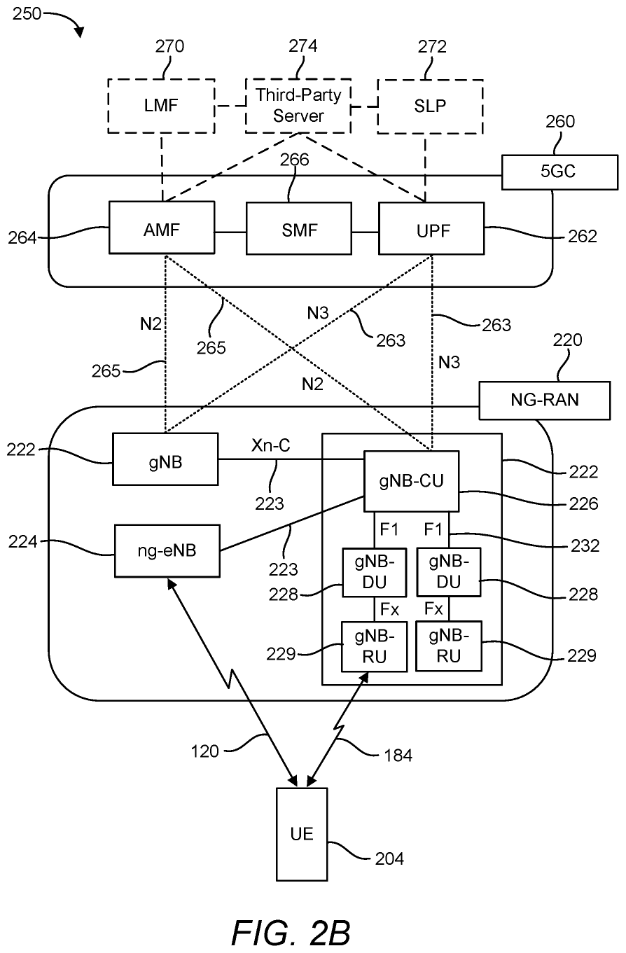

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

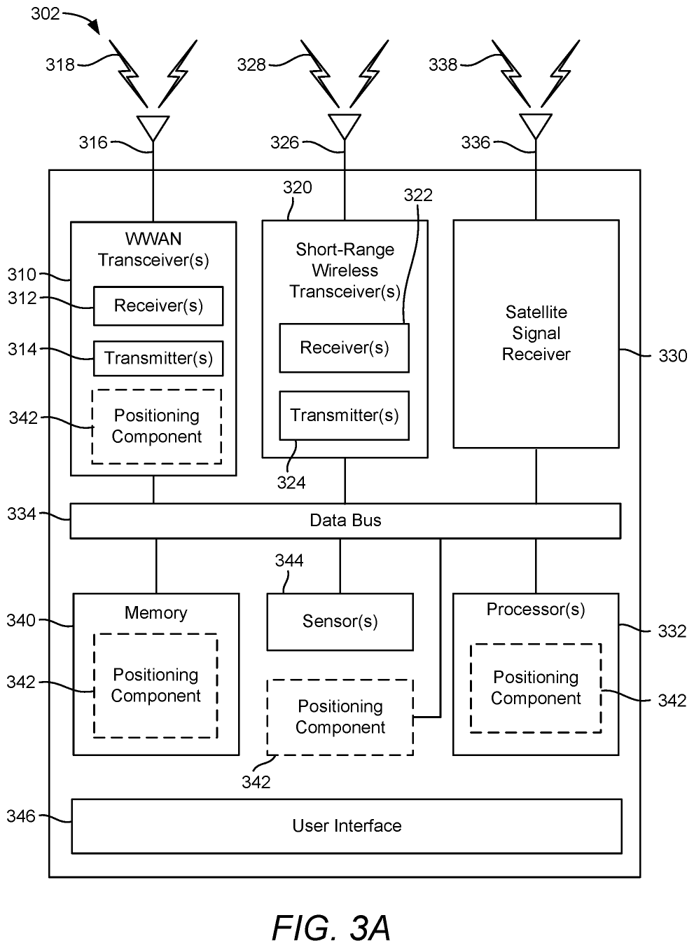

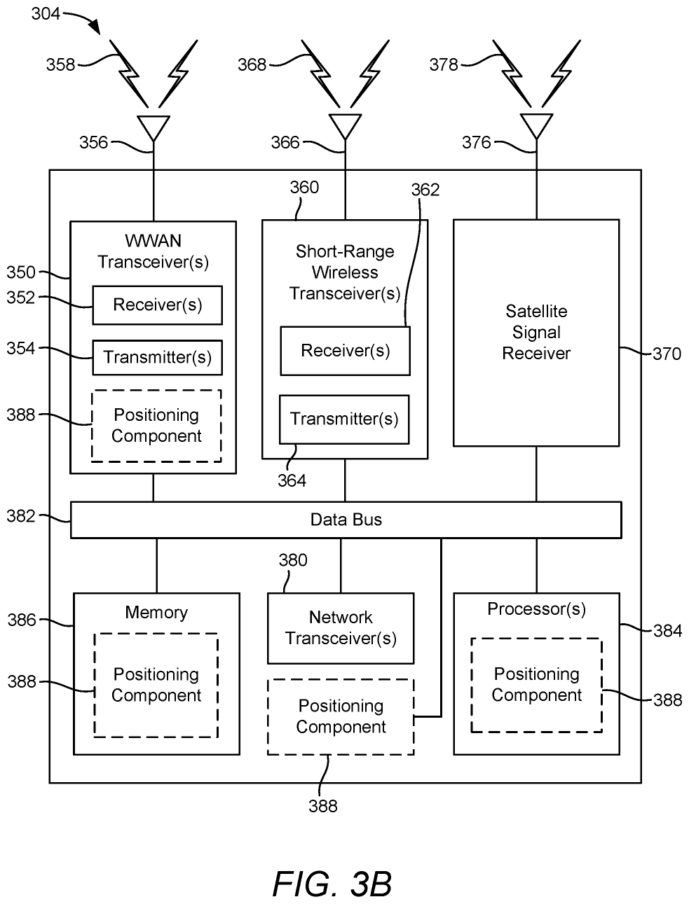

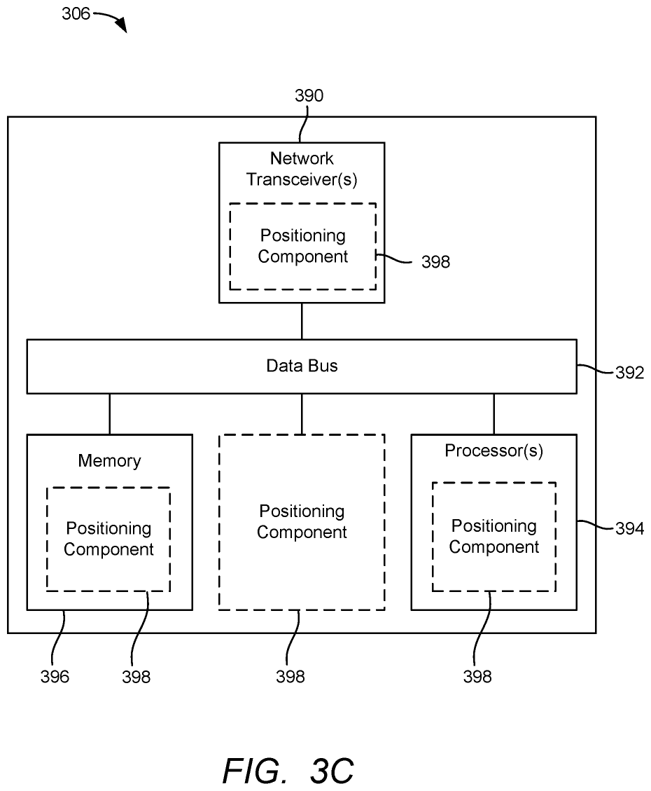

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

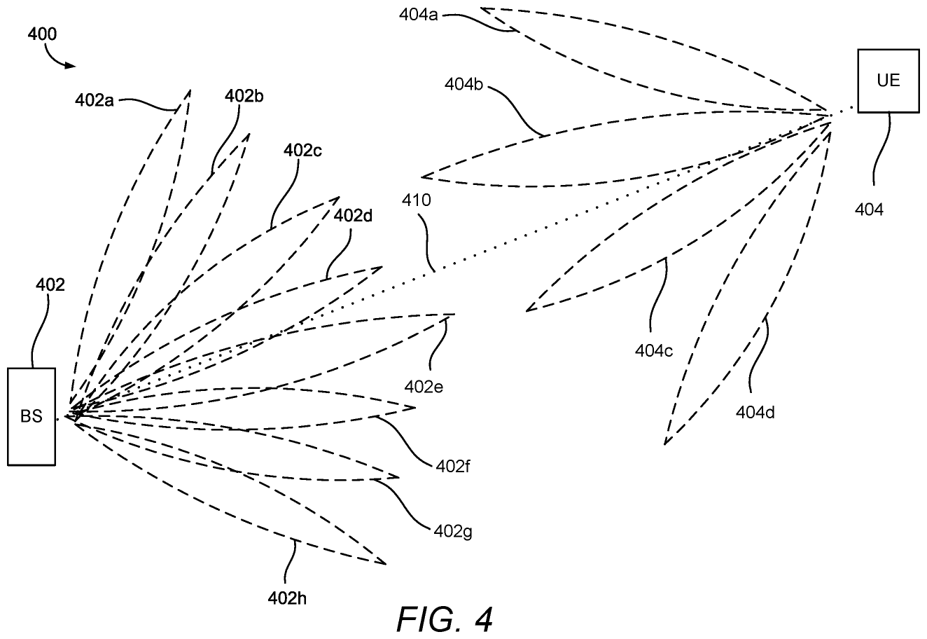

FIG. 4 is a diagram 400 illustrating a base station (BS) 402 (which may correspond to any of the base stations described herein) in communication with a UE 404 (which may correspond to any of the UEs described herein). Referring to FIG. 4, the base station 402 may transmit a beamformed signal to the UE 404 on one or more transmit beams 402a, 402b, 402c, 402d, 402e, 402f, 402g, 402h, each having a beam identifier that can be used by the UE 404 to identify the respective beam. Where the base station 402 is beamforming towards the UE 404 with a single array of antenna elements (e.g., a single antenna panel corresponding to a single TRP), the base station 402 may perform a “beam sweep” by transmitting first beam 402a, then beam 402b, and so on until lastly transmitting beam 402h. Alternatively, the base station 402 may transmit beams 402a-402h in some pattern, such as beam 402a, then beam 402h, then beam 402b, then beam 402g, and so on. Where the base station 402 is beamforming towards the UE 404 using multiple antenna panels (e.g., multiple TRPs), each antenna panel may perform a beam sweep of a subset of the beams 402a-402h. Alternatively, each of beams 402a-402h may correspond to a single antenna or antenna panel.

The UE 404 may receive the beamformed signal from the base station 402 on one or more receive beams 404a, 404b, 404c, 404d. Note that for simplicity, the beams illustrated in FIG. 4 represent either transmit beams or receive beams, depending on which of the base station 402 and the UE 404 is transmitting and which is receiving. Thus, the UE 404 may also transmit a beamformed signal to the base station 402 on one or more of the beams 404a-404d, and the base station 402 may receive the beamformed signal from the UE 404 on one or more of the beams 402a-402h.

In an aspect, the base station 402 and the UE 404 may perform beam training to align the transmit and receive beams of the base station 402 and the UE 404. For example, depending on environmental conditions and other factors, the base station 402 and the UE 404 may determine that the best transmit and receive beams are 402d and 404b, respectively, or beams 402e and 404c, respectively. The direction of the best transmit beam for the base station 402 may or may not be the same as the direction of the best receive beam, and likewise, the direction of the best receive beam for the UE 404 may or may not be the same as the direction of the best transmit beam. Note, however, that aligning the transmit and receive beams is not necessary to perform an AoD or AoA positioning procedure.

Although NR currently supports DL-AoD and UL-AoA positioning and not UL-AoD (the angle of the uplink transmit beam used to transmit reference signals to the base station 402) or DL-AoA (the angle of the downlink receive beam used to receive reference signals from the base station 402), these positioning techniques are expected to be supported in future releases of 5G NR. To perform an UL-AoD positioning procedure, the UE 404 may transmit uplink reference signals (e.g., UL-PRS, SRS, DMRS, etc.) to the base station 402 on one or more of beams 404a-404d, with each beam having a different weight. The different weights of the beams will result in different received signal strengths (e.g., RSRP, RSRQ, SINR, etc.) at the base station 402. Further, the channel impulse response will be smaller for transmit beams that are further from the actual line of sight (LOS) path 410 between the base station 402 and the UE 404 than for transmit beams that are closer to the LOS path 410. Likewise, the received signal strength will be lower for transmit beams that are further from the LOS path 410 than for transmit beams that are closer to the LOS path 410.

In the example of FIG. 4, if the UE 404 transmits reference signals to the base station 402 on uplink transmit beams 404a, 404b, 404c, then transmit beam 404b may be best aligned with the LOS path 410, while transmit beams 404a and 404c may not be. As such, beam 404b will have a stronger channel impulse response and higher received signal strength at the base station 402 than beams 404a and 404c. The base station 402 can report the channel impulse response and received signal strength of each measured transmit beam 404a, 404b, 404c to the UE 404 (or other positioning entity), or alternatively, the identity of the transmit beam having the strongest channel impulse response and highest received signal strength (beam 404b in the example of FIG. 4). In either case, the UE 404 (or other positioning entity) can estimate the angle from itself to the base station 402 as the AoD of the transmit beam having the highest received signal strength and strongest channel impulse response at the base station 402, here, transmit beam 404b.

In one aspect of AoD-based positioning, the base station 402 and the UE 404 can perform an RTT procedure to determine the distance between the base station 402 and the UE 404. Thus, the UE 404 (or location server or other positioning entity) can determine both the direction to the base station 402 (using UL-AoD positioning) and the distance to the base station 402 (using RTT positioning) to estimate the location of the UE 404. Note that the AoD of the transmit beam having the highest received signal strength and strongest channel impulse response does not necessarily lie along the LOS path 410, as shown in FIG. 4. However, for AoD-based positioning purposes, it is assumed to do so. With the UL-AoD measurement(s) to the base station 402, knowledge of the base station's 402 geographic location, and optionally the distance between the UE 404 and the base station 402 (as determined using RTT), the positioning entity (the UE 404 or other) can estimate the location of the UE 404 as the determined distance from the base station 402 along the determined angle.

To perform a DL-AoA positioning procedure, the base station 402 transmits downlink reference signals (e.g., PRS, TRS, PTRS, CRS, CSI-RS, etc.) to the UE 404 on one or more of downlink transmit beams 402a-402h. The UE 404 receives the downlink reference signals on one or more of downlink receive beams 404a-404d. The UE 404 determines the angle of the best receive beams 404a-404d used to receive the one or more reference signals from the base station 402 as the DL-AoA from itself to the base station 402. Specifically, each of the receive beams 404a-404d will result in a different received signal strength (e.g., RSRP, RSRQ, SINR, etc.) of the one or more reference signals at the UE 404. Further, the channel impulse response of the one or more reference signals will be smaller for receive beams 404a-404d that are further from the actual LOS path 410 between the base station 402 and the UE 404 than for receive beams 404a-404d that are closer to the LOS path 410. Likewise, the received signal strength will be lower for receive beams 404a-404d that are further from the LOS path 410 than for receive beams 404a-404d that are closer to the LOS path 410. As such, the UE 404 identifies the receive beam 404a-404d that results in the highest received signal strength and the strongest channel impulse response, and estimates the angle from itself to the base station 402 as the DL-AoA of that receive beam 404a-404d. Note that as with AoD-based positioning, the AoA of the receive beam 404a-404d resulting in the highest received signal strength and strongest channel impulse response does not necessarily lie along the LOS path 410. However, for AoA-based positioning purposes, it is assumed to do so.

As with an UL-AoD positioning procedure, the UE 404 can also estimate the distance between itself and the base station 402 by performing an RTT positioning procedure with the base station 402 or, more coarsely, from the timing advance of the UE 404. The timing advance is roughly based on the propagation delay between a base station and a UE, and therefore, can provide a coarse estimate of the distance between the base station 402 and the UE 404.

Where the UE 404 is estimating its location (i.e., the UE is the positioning entity), it needs to obtain the geographic location of the base station 402. The UE 404 may obtain the location from, for example, the base station 402 itself or a location server (e.g., location server 230, LMF 270, SLP 272). With the knowledge of the distance to the base station 402 (based on the RTT or timing advance), the angle between the UE 404 and the base station 402 (based on the AoA of the best receive beam 404a-404d), and the known geographic location of the base station 402, the UE 404 can estimate its location.

Alternatively, where another positioning entity, such as the base station 402 or a location server, is estimating the location of the UE 404, the UE 404 reports the DL-AoA of the receive beam 404a-404d resulting in the highest received signal strength and strongest channel impulse response of the reference signals received from the base station 402, or all received signal strengths and channel impulse responses for all receive beams 404a-404d (which allows the positioning entity to determine the best receive beam 404a-404d). The UE 404 may additionally report the distance to the base station 402. The positioning entity can then estimate the location of the UE 404 based on the UE's 404 distance to the base station 402, the AoA of the identified receive beam 404a-404d, and the known geographic location of the base station 402.

Note that although the foregoing has described UL-AoD and DL-AoA positioning techniques, DL-AoD (the angle of the downlink transmit beam used to transmit reference signals to the UE 404) and UL-AoA (the angle of the uplink receive beam used to receive reference signals from the UE 404) positioning techniques are the same, except that the roles of the base station 402 and the UE 404 are reversed. These techniques are described in the current NR specification and are therefore not described in detail here.

Direction finding is an important location feature. Many wireless systems, including the Bluetooth® 5.1 specification, the ultra-wideband (UWB) 802.15.4z specification, the IEEE 802.11az specification (known as “Wi-Fi”), and the 5G NR Release 16 standards (the current set of 5G NR standards), have provided standards support to facilitate the estimation of AoA and/or AoD for positioning. AoA and AoD estimation algorithms (collectively angle estimation algorithms) are usually designed independently of the types of antennas (e.g., directional versus omnidirectional) of the devices (e.g., base stations and UEs) that may utilize the algorithms. This means that the algorithms are typically designed to work with any type of antenna and any antenna placement (e.g., the distance between antennas, which may differ for UEs and base stations). However, angle estimation accuracy is tightly coupled with the type of antenna and/or the antenna placement on the device. Thus, AoA and AoD estimation algorithms could be optimized in very different ways for, for example, directional antennas versus omnidirectional antennas and for antennas placed closely together versus antennas placed further apart. As such, using a universal algorithm instead of optimizing the algorithm based on antenna information can cause significant accuracy degradation in angle estimation.

The present disclosure provides techniques for optimizing angle estimation algorithms by using antenna information, such as antenna type, antenna placement, antenna beam width, and antenna coordinates. The present disclosure further proposes standards changes to provide antenna beam width information for the IEEE 802.11az standard and the 5G NR Release 17 standards (and other standards that support angle-based measurements). This information is important for optimizing angle estimation algorithms, and AoD estimation algorithms in particular. Note that although the following description refers primarily to the IEEE 802.11az and 5G NR Release 17 standards, these standards are merely examples, and the techniques described herein are equally applicable to other wireless standards that support angle-based positioning.

To optimize an angle estimation algorithm (for AoA or AoD), the antenna type and antenna placement need to be known for the device (e.g., base station or UE) receiving (for AoA) or transmitting (for AoD) the reference signals. Referring first to the antenna type, the antenna type refers to whether the antenna is an omnidirectional antenna or a directional antenna (i.e., capable of beamforming). For an omnidirectional antenna, the beam width is considered to be 360 degrees. For a directional antenna, the beam width is W degrees (less than 360 degrees). The beam width determines the optimal distance between the antennas of the device (i.e., a device may have multiple antennas, and those antennas are separated by some distance). For example, the optimal antenna spacing “Dₒₚₜ” can be given as Dₒₚₜ=λ*180/W, where λ is the wavelength of the reference signal transmitted by or received on the antenna. For an omnidirectional antenna, Dₒₚₜ=λ/2 (i.e., λ*180/360). For a directional antenna with a beam width of 40 degrees, Dₒₚₜ=4.5λ (i.e., λ*180/40). For a directional antenna with a beam width of 120 degrees, Dₒₚₜ=1.5λ (i.e., λ*180/120).

Referring to antenna placement, antenna placement means the coordinates (e.g., x, y, z) of each antenna on the device. The coordinates may specify the center point of the antenna, the length and width of the antenna, the area of the antenna, or any combination thereof. The coordinates may be relative to a fixed point on the device or to a reference antenna of the multiple antennas. A device may report the coordinates of its antennas, or the type of the device (e.g., manufacturer and model) and/or the number and type of the antennas (e.g., manufacturer and model). In the latter case, the positioning entity can use a lookup table to determine the coordinates of the antennas.

The coordinates of the antenna placement parameter can be used to calculate the antenna spacing between the antennas. If the actual antenna spacing “D” is greater than Dₒₚₜ, it may cause ambiguity in the angle estimation. If, however, the actual antenna spacing “D” is less than Dₒₚₜ, it may reduce angle estimation resolution. Thus, it would be preferable for the actual antenna spacing “D” to be equal to the optimal antenna spacing “Dₒₚₜ.” However, this may not always be the case. Knowing the beam width will give Dₒₚₜ, and knowing the antenna coordinates will give D. If the two parameters are not equal, this information will indicate whether the angle estimation algorithm needs to be designed to also solve the ambiguity issue, as well as what angle estimation resolution can be achieved.

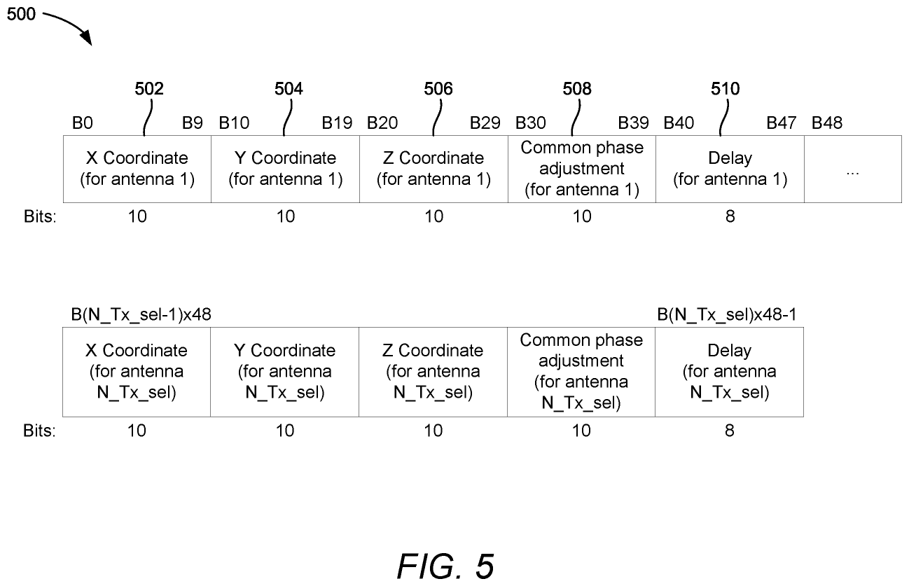

FIG. 5 illustrates an example format of an antenna placement and calibration information element (IE), as defined in the IEEE 802.11az standard, that a device may report for angle-based positioning purposes. Specifically, FIG. 5 illustrates two 48-bit antenna placement and calibration IEs for the first and last antennas of a device (where the reporting device has N_{Tx_sel} antennas, denoted “N_Tx_sel” in the figure). If the device has more than two antennas (e.g., a Wi-Fi client may have two omnidirectional antennas, whereas a Wi-Fi access point, including a UE that is also a Wi-Fi access point, may have four omnidirectional antennas), the antenna placement and calibration IEs for the other antennas would be the same as the illustrated IEs. Each antenna placement and calibration IE includes a 10-bit x-coordinate field 502, a 10-bit y-coordinate field 504, a 10-bit z-coordinate field 506, a 10-bit common phase adjustment field 508, and an 8-bit delay field 510. A UE or access point may provide this information to a positioning entity (e.g., location server 230, LMF 270, SLP 272) or other entity executing the angle estimation algorithm.

The x-coordinate field 502, the y-coordinate field 504, and the z-coordinate field 506 provide the coordinates of the respective antenna on the device, and thereby provide the antenna placement on the device for the respective antenna. However, the beam width of the antenna is not currently reported. The present disclosure proposes to add a new field (e.g., after the delay field 510) to report the antenna beam width for each respective antenna. Such a beam width field may be, for example, a 9-bit field that conveys a value from 1 degree to 360 degrees at one-degree steps (increments). As another example, the beam width field may be more than nine bits to improve the angle resolution to greater than one degree. Alternatively, the beam width field may be less than nine bits if a resolution of one-degree steps is not needed.

With the information in the proposed antenna placement and calibration IE, the positioning entity can optimize the angle estimation algorithm based on the antenna type (which is assumed to be omnidirectional for the IEEE 802.11az standard) and antenna placement.

Referring to positioning in 5G NR, positioning procedures in 5G NR are modeled as transactions of the LTE positioning protocol (LPP). An LPP procedure consists of a single operation of one of the following types: (1) exchange of positioning capabilities; (2) transfer of assistance data; (3) transfer of location information (positioning measurements and/or location estimate); (4) error handling; or (5) abort.

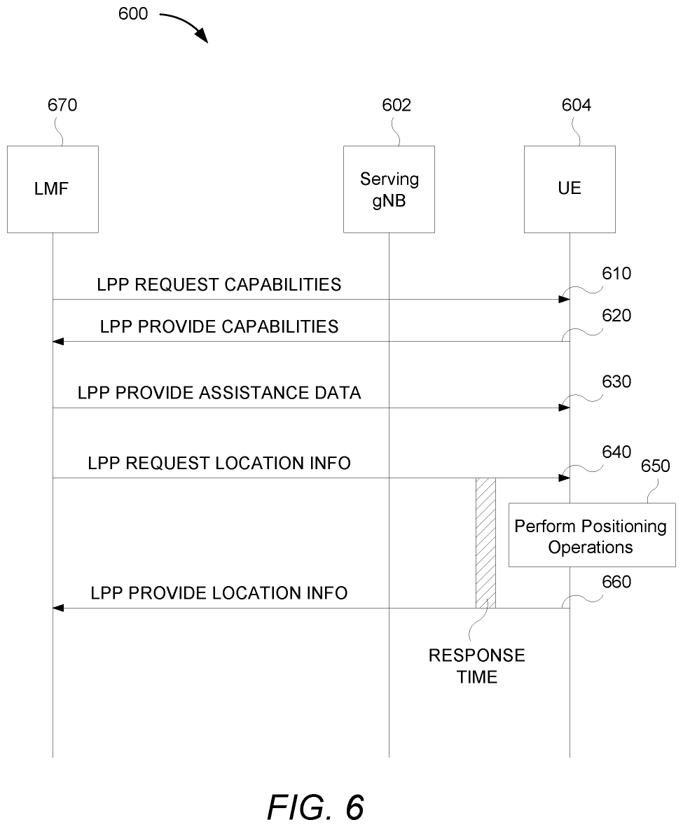

FIG. 6 illustrates an example LPP procedure 600 between a UE 604 and a location server (illustrated as an LMF 670) for performing positioning operations. As illustrated in FIG. 6, positioning of the UE 604 is supported via an exchange of LPP messages between the UE 604 and the LMF 670. The LPP messages may be exchanged between UE 604 and the LMF 670 via the UE's 604 serving base station (illustrated as a serving gNB 602) and a core network (not shown). The LPP procedure 600 may be used to position the UE 604 in order to support various location-related services, such as navigation for UE 604 (or for the user of UE 604), or for routing, or for provision of an accurate location to a public safety answering point (PSAP) in association with an emergency call from UE 604 to a PSAP, or for some other reason. The LPP procedure 600 may also be referred to as a positioning session, and there may be multiple positioning sessions for different types of positioning methods (e.g., downlink time difference of arrival (DL-TDOA), round-trip-time (RTT), enhanced cell identity (E-CID), etc.).

Initially, the UE 604 may receive a request for its positioning capabilities from the LMF 670 at stage 610 (e.g., an LPP Request Capabilities message). At stage 620, the UE 604 provides its positioning capabilities to the LMF 670 relative to the LPP protocol by sending an LPP Provide Capabilities message to LMF 670 indicating the position methods and features of these position methods that are supported by the UE 604 using LPP. The capabilities indicated in the LPP Provide Capabilities message may, in some aspects, indicate that the UE 604 supports angle-based positioning and may indicate the capabilities of the UE 604 to support angle-based positioning.

Upon reception of the LPP Provide Capabilities message, the LMF 670 determines to use an angle-based positioning method (e.g., AoD or AoA) based on the indicated UE 604 support for angle-based positioning at stage 620 and determines a set of one or more transmission-reception points (TRPs) from which the UE 604 is to measure downlink positioning reference signals or towards which the UE 604 is to transmit uplink positioning reference signals. At stage 630, the LMF 670 sends an LPP Provide Assistance Data message to the UE 604 identifying the set of TRPs.

In some implementations, the LPP Provide Assistance Data message at stage 630 may be sent by the LMF 670 to the UE 604 in response to an LPP Request Assistance Data message sent by the UE 604 to the LMF 670 (not shown in FIG. 6). An LPP Request Assistance Data message may include an identifier of the UE's 604 serving TRP and a request for the positioning reference signal (PRS) configuration of neighboring TRPs.

At stage 640, the LMF 670 sends a request for location information to the UE 604. The request may be an LPP Request Location Information message. This message usually includes information elements defining the location information type, desired accuracy of the location estimate, and response time (i.e., desired latency). Note that a low latency requirement allows for a longer response time while a high latency requirement requires a shorter response time. However, a long response time is referred to as high latency and a short response time is referred to as low latency.

Note that in some implementations, the LPP Provide Assistance Data message sent at stage 630 may be sent after the LPP Request Location Information message at 640 if, for example, the UE 604 sends a request for assistance data to LMF 670 (e.g., in an LPP Request Assistance Data message, not shown in FIG. 6) after receiving the request for location information at stage 640.

At stage 650, the UE 604 utilizes the assistance information received at stage 630 and any additional data (e.g., a desired location accuracy or a maximum response time) received at stage 640 to perform angle-based measurements (e.g., AoA and/or AoD) for the angle-based positioning method. For example, for UL-AoD, the UE 604 may transmit SRS on time and/or frequency resources specified by the gNB 602 towards TRPs identified in the assistance information. For DL-AoA, the UE 604 may receive PRS on time and/or frequency resources specified in the assistance information from one or more TRPs identified in the assistance information. The UE 604 may also determine the best receive beam for receiving the PRS.

At stage 660, the UE 604 may send an LPP Provide Location Information message to the LMF 670 conveying the angle-based measurements that were obtained at stage 650 and before or when any maximum response time has expired (e.g., a maximum response time provided by the LMF 670 at stage 640). The LPP Provide Location Information message at stage 660 may also include the time (or times) at which the angle-based measurements were obtained and the identity of the TRP(s) for the angle-based measurements. The LPP Provide Location Information message may further include antenna information as described herein. Note that the time between the request for location information at 640 and the response at 660 is the “response time” and indicates the latency of the positioning session.

The LMF 670 computes an estimated location of the UE 604 using angle-based positioning techniques based, at least in part, on measurements received in the LPP Provide Location Information message at stage 660.

The present disclosure provides techniques to report a UE's antenna placement and beam pattern information for NR positioning. During a positioning session (e.g., when a UE has received an LPP Request Location Information message and is expected to respond with an LPP Provide Location Information message), the UE can send its antenna placement (in local or global coordinates) and the beam pattern of each antenna and/or each antenna panel to the location server (e.g., LMF). As discussed further below, the UE may also send the orientation of its antennas to the location server.

As a first option, the UE may provide this information in the UE capability report (e.g., the LPP Provide Capabilities message at 610 of FIG. 6). As a second option, the UE may provide this information in the assistance data request (e.g., an LPP Request Assistance Data message, not shown in FIG. 6). For example, when the UE requests assistance data, it can inform the location server of the antenna patterns (e.g., beam widths) and antenna locations (i.e., antenna placements) of its active antennas. For example, a UE may have two to four antennas (e.g., antenna panels), some or all of which may be active for an angle-based positioning session. As a third option, the UE may include the antenna patterns and antenna locations of its active antennas in a location information message (e.g., the LPP Provide Location Information message at 660 of FIG. 6). More specifically, when the UE reports its positioning measurements, it can also inform the location server of the antenna patterns and antenna locations of the antenna panels that were active when the UE performed the positioning measurements.

In an aspect, a UE may report the antenna placement, orientation, and/or beam information for an antenna dynamically (e.g., in uplink control information (UCI) or MAC control element (MAC-CE)). Alternatively, the UE may report these parameters semi-statically (e.g., in RRC signaling or LPP messages). The UE may report these parameters to the serving base station, the location server (e.g., an LMF), or another UE connected over a sidelink with the reporting UE.

The preceding description generally applies to both the reception of downlink reference signals at the UE from one or more base stations (for DL-AoA) and the transmission of uplink reference signals by the UE towards one or more base stations (for UL-AoD). That is, the angle-based positioning techniques referred to above may be either DL-AoA or UL-AoD positioning techniques. For UL-AoD positioning techniques specifically, the reporting of boresight (i.e., direction) and beam width can be associated to each SRS resource separately.

More specifically, in 5G NR, uplink positioning reference signals are typically SRS. Thus, the reference signals transmitted by the UE for UL-AoD positioning would be SRS. A collection of resource elements (in 5G, a resource element consists of one OFDM symbol in the time domain and one subcarrier, or tone, in the frequency domain) that are used for the transmission of SRS is referred to as an “SRS resource,” and may be identified by the parameter “SRS-ResourceId.” The collection of resource elements can span multiple consecutive physical resource blocks (PRBs) in the frequency domain and N (e.g., one or more) consecutive symbol(s) within a slot in the time domain. In a given OFDM symbol, an SRS resource occupies consecutive PRBs. An “SRS resource set” is a set of SRS resources used for the transmission of SRS signals, and is identified by an SRS resource set ID (“SRS-ResourceSetId”).

An SRS resource may correspond to an uplink transmit beam. That is, a UE may transmit each SRS resource on a different uplink transmit beam. Said another way, each uplink transmit beam may carry a different SRS resource. Thus, the reporting of boresight and beam width can be associated to, and reported for, each SRS resource separately.

The following parameters may be used to define the boresight and beam width of an SRS resource (i.e., the beam carrying the SRS resource). These parameters may be reported to the location server (e.g., LMF) via LPP as described above. For example, these parameters may be provided in an LPP Request Assistance Data message or an LPP Provide Location Information message. These parameters may be in addition to the antenna placement parameters described above.

The first parameter is an SRS-Azimuth parameter. This parameter specifies the azimuth angle of the boresight direction in which the SRS resource(s) associated with this SRS resource identifier (e.g., “SRS-ResourceId”) in the SRS resource set (e.g., “SRS-ResourceSetId”) are transmitted. The azimuth angle is measured clockwise from geographic North. The value of this parameter may be reported in increments of, for example, 0.5 degrees and range from, for example, 0 to 359.5 degrees.

Second, an SRS-Elevation parameter. This parameter specifies the elevation angle of the boresight direction in which the SRS resource(s) associated with this SRS resource identifier in the SRS resource set are transmitted. The elevation angle is the angle between the horizontal plane at the antenna reference point location and the boresight direction, measured in the vertical plane. Positive angles point in directions above the horizontal plane (upwards), and negative angles point in directions below the horizontal plane (downwards). If this field is absent, the boresight direction is the same along the vertical plane. The value of this parameter may be reported in increments of, for example, 0.5 degrees and range from, for example, −90 to +90 degrees.

Third, an SRS-HPBW-Az parameter. This parameter specifies the half-power beam width (HPBW) in the horizontal (azimuth) plane of the beam in which the SRS resource(s) associated with this SRS resource identifier in the SRS resource set are transmitted. The HPBW-Az is the angle subtended by the half-power points of the main lobe in the horizontal (azimuth) plane. The value of this parameter may be reported in increments of, for example, 0.5 degrees and range from, for example, 0 to 120 degrees.

Fourth, an SRS-HPBW-El parameter. This parameter specifies the HPBW in the vertical (elevation) plane of the beam in which the SRS resource(s) associated with this SRS Resource identifier in the SRS resource set are transmitted. The HPBW-El is the angle subtended by the half-power points of the main lobe in the vertical (elevation) plane. The value of this parameter may be reported in increments of, for example, 0.5 degrees and range from, for example, 0 to 120 degrees.

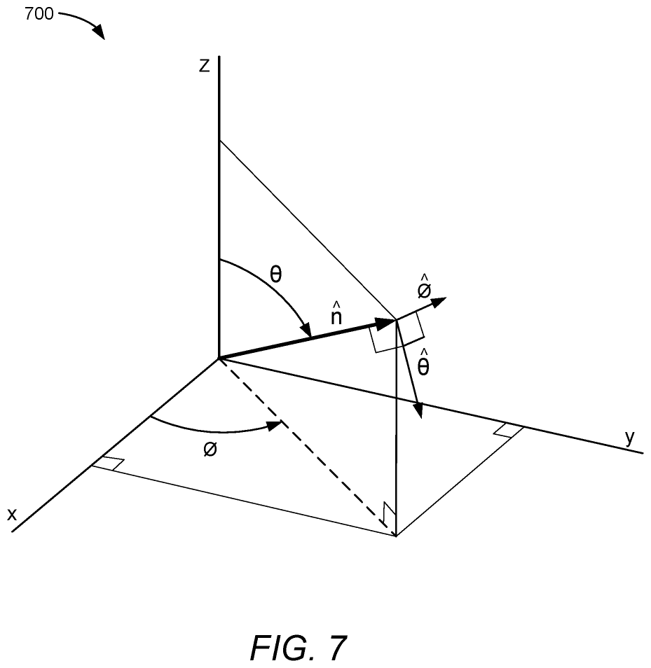

In an aspect, a UE can report the measured/estimated/derived/computed angle values (e.g., DL-AoA, UL-AoD) to the positioning entity (e.g., the serving base station, location server 230, LMF 270, SLP 272, etc.) in either the UE's local coordinate system (LCS) or a global coordinate system (GCS). A coordinate system is defined by the x, y, z axes, the spherical angles, and the spherical unit vectors, as shown in FIG. 7. FIG. 7 illustrates the definition of spherical angles and spherical unit vectors in a Cartesian coordinate system 700, according to aspects of the disclosure. In FIG. 7, θ is the zenith angle and Ø is the azimuth angle in the Cartesian coordinate system 700. Further, \hat{n} is the given direction, and \hat{θ} and \hat{Ø} are the spherical basis vectors. Note that θ=0 points to the zenith and θ=90 points to the horizon. The field component in the direction of \hat{θ} is given by F_{θ} and the field component in the direction of \hat{Ø} is given by F_{Ø}.

A GCS is defined for a system comprising multiple base stations and UEs. An array antenna for UE (or a base station) can be defined in an LCS. A GCS has an absolute reference frame (e.g., in terms of absolute latitude and longitude), whereas an LCS has a relative reference frame (e.g., relative to a vehicle, a base station, an antenna array, etc.). An LCS is used as a reference to define the vector far-field, that is pattern and polarization, of each antenna element in an array. It is assumed that the far-field is known in the LCS by formulae. The placement of an antenna array within the GCS is defined by the translation between the GCS and the LCS for the antenna array. The orientation of the antenna array with respect to the GCS is defined in general by a sequence of rotations (described in 3GPP Technical Specification (TS) 38.900 and TS 38.901, which are publicly available and which are incorporated by reference herein in their entirety). Since this orientation is in general different from the GCS orientation, it is necessary to map the vector fields of the array elements from the LCS to the GCS. This mapping depends on the orientation of the array and is given by the equations in 3GPP TS 38.900. Note that any arbitrary mechanical orientation of the array can be achieved by rotating the LCS with respect to the GCS.

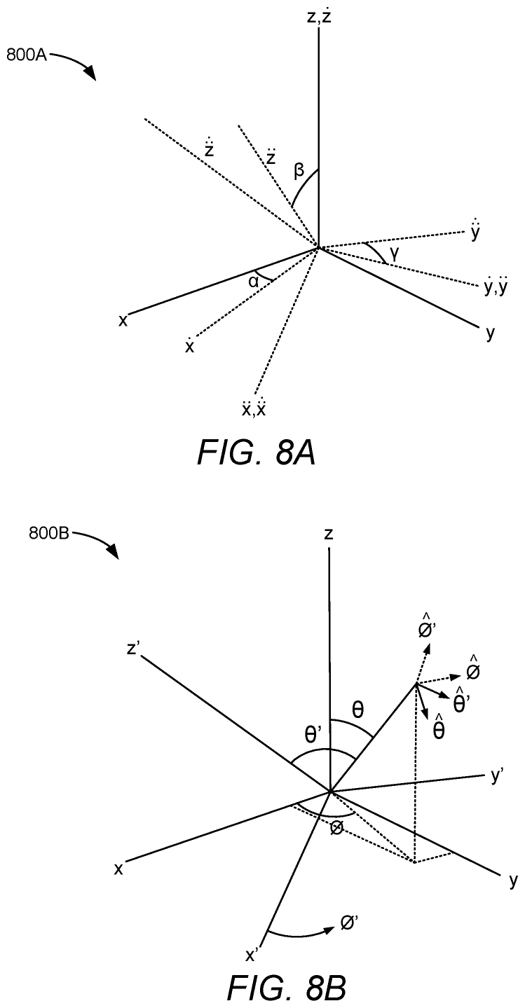

In FIGS. 8A and 8B, a GCS with coordinates (x, y, z, θ, Ø) and unit vectors (\hat{θ}, \hat{Ø}), and an LCS with “primed” coordinates (x′, y′, z′, θ′, Ø′) and “primed” unit vectors (\hat{θ}′, \hat{Ø}′), are defined with a common origin. FIG. 8A is a diagram 800A illustrating the sequence of rotations that relate the GCS coordinates (x, y, z) and the LCS coordinates ( [symbol] , [symbol] , [symbol] ), according to aspects of the disclosure. More specifically, FIG. 8A illustrates an arbitrary three-dimensional (3D) rotation of the LCS with respect to the GCS given by the angles α, β, γ. The set of angles α, β, γ can also be termed as the orientation of the antenna array with respect to the GCS. Specifically, α (alpha) specifies the bearing angle for the translation of the LCS to the GCS. The value of this parameter may be reported in increments of, for example, one degree and range from, for example, 0 to 359 degrees. β (beta) specifies the downtilt angle for the translation of the LCS to the GCS. The value of this parameter may be reported in increments of, for example, one degree and range from, for example, 0 to 359 degrees. γ (gamma) specifies the slant angle for the translation of the LCS to the GCS. The value of this parameter may be reported in increments of, for example, one degree and range from, for example, 0 to 359 degrees. In an aspect, the UE may be able to determine the angles α, β, γ based on orientation data from its accelerometer, gyroscope, magnetometer, and/or other orientation sensor.

Any arbitrary 3D rotation can be specified by at most three elemental rotations, and following the framework of FIG. 8A, a series of rotations about the z, \dot{y}, and \ddot{x} axes are assumed, in that order. The dotted and double-dotted marks indicate that the rotations are intrinsic, which means that they are the result of one (⋅) or two (⋅⋅) intermediate rotations. In other words, the \dot{y} axis is the original y axis after the first rotation about the z axis, and the \ddot{x} axis is the original x axis after the first rotation about the z axis and the second rotation about the \dot{y} axis.

A first rotation of a about z sets the antenna bearing angle (i.e., the sector pointing direction for a base station antenna element). The second rotation of β about \dot{y} sets the antenna downtilt angle. Finally, the third rotation of γ about \ddot{x} sets the antenna slant angle. The orientation of the x, y, and z axes after all three rotations can be denoted as [symbol] , [symbol] , and [symbol] . These triple-dotted axes represent the final orientation of the LCS, and for notational purposes, are denoted as the x′, y′, and z′ axes (local or “primed” coordinate system). Note that the transformation from an LCS to a GCS depends only on the angles α, β, γ. The angle α is called the bearing angle, β is called the downtilt angle, and γ is called the slant angle.

FIG. 8B is a diagram 800B illustrating the definition of spherical coordinates and unit vectors in both the GCS and LCS, according to aspects of the disclosure. FIG. 8B shows the coordinate direction and unit vectors of the GCS coordinates (x, y, z) and the LCS coordinates (x′, y′, z′). Note that the vector fields of the antenna array elements are defined in the LCS.

In an aspect, the reporting of the beam width, orientation, boresight direction, location(s) (placement) of antenna(s), etc. of different antennas or antenna panels (or SRS resources) may be reported in a differential, or relative, manner, thereby reducing signaling overhead. For example, one antenna or antenna panel may be the reference antenna, and the UE may report absolute values for the parameters for this antenna. The UE may then report the values for the parameters for the remaining antennas relative to the absolute values for the reference antenna. For example, if the beam width of the reference antenna is 39.5 degrees and the beam width of a second antenna is 41 degrees, the UE may report the value of 39.5 degrees for the beam width parameter of the reference antenna and the value of +1.5 degrees for the beam width parameter of the second antenna.

Note that while the foregoing description has referred primarily to the IEEE 802.11az and 5G NR Release 17 standards, these standards are merely examples, and the techniques described herein are equally applicable to other wireless technologies that support angle-based positioning. For example, the techniques described above are equally applicable to Bluetooth®, UWB, and any other wireless technology in which a UE transmits or receives reference signals for positioning.

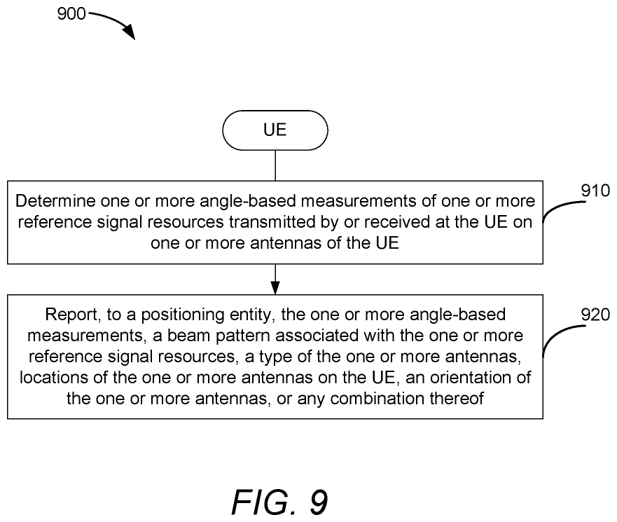

FIG. 9 illustrates an example method 900 of wireless positioning, according to aspects of the disclosure. In an aspect, method 900 may be performed by a UE (e.g., any of the UEs described herein).

At 910, the UE determines one or more angle-based measurements of one or more reference signal resources transmitted by or received at the UE on one or more antennas of the UE. In an aspect, operation 910 may be performed by the one or more WWAN transceivers 310, the one or more processors 332, memory 340, and/or positioning component 342, any or all of which may be considered means for performing this operation.

At 920, the UE reports, to a positioning entity (e.g., a location server, the serving base station, another UE connected over a sidelink, etc.), the one or more angle-based measurements, a beam pattern (e.g., beam width) associated with the one or more reference signal resources, a type of the one or more antennas, locations of the one or more antennas on the UE, an orientation of the one or more antennas, or any combination thereof. In an aspect, operation 920 may be performed by the one or more WWAN transceivers 310, the one or more processors 332, memory 340, and/or positioning component 342, any or all of which may be considered means for performing this operation.

As will be appreciated, a technical advantage of the method X00 is that the positioning entity can optimize the angle estimation algorithm based on the one or more angle-based measurements, the beam width associated with the one or more reference signal resources, the type of the one or more antennas, the locations of the one or more antennas on the UE, and/or the orientation of the one or more antennas.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless communication positioning by a user equipment (UE), comprising: determining one or more angle-based measurements of one or more reference signal resources transmitted by or received at the UE on one or more antennas of the UE; and reporting, to a positioning entity, the one or more angle-based measurements, a beam pattern associated with the one or more reference signal resources, a type of the one or more antennas, locations of the one or more antennas on the UE, an orientation of the one or more antennas, or any combination thereof.

Clause 2. The method of clause 1, wherein the one or more angle-based measurements comprise an uplink angle of departure (UL-AoD) measurement.

Clause 3. The method of clause 2, wherein the one or more reference signal resources comprise one or more sounding reference signals (SRS) resources.

Clause 4. The method of clause 3, wherein the UL-AoD measurement comprises: an azimuth angle of a boresight direction in which the one or more SRS resources are transmitted, and an elevation angle of the boresight direction in which the one or more SRS resources are transmitted.

Clause 5. The method of clause 4, wherein the reporting comprises: reporting the azimuth angle to the positioning entity in an SRS-azimuth field, and reporting the elevation angle to the positioning entity in an SRS-elevation field.

Clause 6. The method of any of clauses 4 to 5, wherein: the azimuth angle is reported as a value from 0 to 359.5 degrees with a step size of 0.5 degrees, and the elevation angle is reported as a value from −90 to +90 degrees with a step size of 0.5 degrees.

Clause 7. The method of any of clauses 3 to 6, wherein the beam pattern comprises: a half-power beam width (HPBW) in a horizontal plane of a beam on which the one or more SRS resources are transmitted, and an HPBW in a vertical plane of the beam on which the one or more SRS resources are transmitted.

Clause 8. The method of clause 7, wherein the reporting comprises: reporting the HPBW in the horizontal plane to the positioning entity in an SRS-HPBW-Az field, and reporting the HPBW in the vertical plane to the positioning entity in an SRS-HPBW-El field.

Clause 9. The method of any of clauses 7 to 8, wherein: the HPBW in the horizontal plane is reported as a value from 0 to 120 degrees with a step size of 0.5 degrees, and the HPBW in the vertical plane is reported as a value from 0 to 120 degrees with a step size of 0.5 degrees.

Clause 10. The method of any of clauses 1 to 9, wherein the orientation of the one or more antennas is reported in a local coordinate system (LCS) of the UE.

Clause 11. The method of clause 10, wherein reporting the orientation of the one or more antennas comprises: reporting a bearing angle (α) of the one or more antennas for a translation of the LCS to a global coordinate system (GCS), reporting a downtilt angle (β) of the one or more antennas for the translation of the LCS to the GCS, and reporting a slant angle (γ) of the one or more antennas for the translation of the LCS to the GCS.

Clause 12. The method of any of clauses 1 to 11, wherein the one or more angle-based measurements, the beam pattern associated with the one or more reference signal resources, the type of the one or more antennas, the locations of the one or more antennas on the UE, the orientation of the one or more antennas, or any combination thereof are reported in: a UE positioning capability report, a request for assistance data, a provide location information message, or any combination thereof.

Clause 13. The method of any of clauses 1 to 12, wherein the one or more angle-based measurements, the beam pattern associated with the one or more reference signal resources, the type of the one or more antennas, the locations of the one or more antennas on the UE, the orientation of the one or more antennas, or any combination thereof are reported in: uplink control information (UCI), medium access control control element (MAC-CE), radio resource control (RRC) signaling, one or more Long-Term Evolution (LTE) positioning protocol (LPP) messages, or any combination thereof.

Clause 14. The method of any of clauses 1 to 13, wherein the positioning entity comprises: a location server, a serving base station of the UE, or another UE connected to the UE over a sidelink.

Clause 15. The method of clause 1, wherein the one or more angle-based measurements comprise a downlink angle of arrival (DL-AoA) measurement.

Clause 16. The method of clause 15, wherein the one or more reference signal resources comprise one or more positioning reference signals (PRS) resources.

Clause 17. The method of clause 16, wherein the DL-AoA measurement comprises: an azimuth angle of a boresight direction in which the one or more PRS resources are received, and an elevation angle of the boresight direction in which the one or more PRS resources are received.

Clause 18. The method of any of clauses 16 to 17, wherein the beam pattern comprises: a half-power beam width (HPBW) in a horizontal plane of a beam on which the one or more PRS resources are received, and an HPBW in a vertical plane of the beam on which the one or more PRS resources are received.

Clause 19. The method of any of clauses 1 to 18, wherein the beam pattern associated with the one or more reference signal resources and the locations of the one or more antennas are reported in one or more antenna placement and calibration information elements (IEs).

Clause 20. The method of clause 19, wherein the locations of the one or more antennas comprise x, y, z coordinates of the one or more antennas.

Clause 21. The method of any of clauses 19 to 20, wherein the beam pattern comprises a value from 1 degree to 360 degrees.

Clause 22. The method of any of clauses 1 to 21, wherein the reporting comprises: reporting the one or more angle-based measurements, the beam pattern associated with the one or more reference signal resources, the locations of the one or more antennas, the orientation of the one or more antennas, or any combination thereof relative to a reference antenna of the one or more antennas.

Clause 23. The method of clause 22, wherein: the one or more antennas comprise a plurality of antennas, the one or more angle-based measurements comprise an angle-based measurement associated with each of the plurality of antennas, the beam pattern associated with the one or more reference signal resources comprise a beam pattern associated with each of the plurality of antennas, the locations of the one or more antennas comprise a location of each of the plurality of antennas, and the orientation of the one or more antennas comprises an orientation of each of the one or more antennas.

Clause 24. The method of clause 23, wherein the reporting comprises: reporting absolute values for the angle-based measurement, the beam pattern, the location, the orientation, or any combination thereof for the reference antenna; and reporting values for the angle-based measurement, the beam pattern, the location, the orientation, or any combination thereof for remaining antennas of the plurality of antennas relative to the absolute values for the reference antenna.

Clause 25. The method of any of clauses 1 to 24, wherein the type of the one or more antennas comprises an omnidirectional antenna.

Clause 26. The method of any of clauses 1 to 24, wherein the type of the one or more antennas comprises a directional antenna capable of beamforming.

Clause 27. The method of any of clauses 1 to 26, further comprising: transmitting the one or more reference signal resources on the one or more antennas of the UE.

Clause 28. The method of any of clauses 1 to 26, further comprising: receiving the one or more reference signal resources on the one or more antennas of the UE.

Clause 29. The method of any of clauses 1 to 28, wherein the beam pattern comprises a beam width associated with the one or more reference signal resources.

Clause 30. The method of any of clauses 1 to 29, wherein: the UE operates in accordance with a radio access technology (RAT), the one or more reference signal resources are configured according to the RAT, and the RAT comprises: LTE, Fifth Generation New Radio (5G NR), Wi-Fi, ultra-wideband (UWB), or Bluetooth.

Clause 31. A user equipment (UE), comprising: a memory; at least one transceiver; and at least one processor communicatively coupled to the memory and the at least one transceiver, the at least one processor configured to: determine one or more angle-based measurements of one or more reference signal resources transmitted by or received at the UE on one or more antennas of the UE; and report, via the at least one transceiver, to a positioning entity, the one or more angle-based measurements, a beam pattern associated with the one or more reference signal resources, a type of the one or more antennas, locations of the one or more antennas on the UE, an orientation of the one or more antennas, or any combination thereof.

Clause 32. The UE of clause 31, wherein the one or more angle-based measurements comprise an uplink angle of departure (UL-AoD) measurement.

Clause 33. The UE of clause 32, wherein the one or more reference signal resources comprise one or more sounding reference signals (SRS) resources.

Clause 34. The UE of clause 33, wherein the UL-AoD measurement comprises: an azimuth angle of a boresight direction in which the one or more SRS resources are transmitted, and an elevation angle of the boresight direction in which the one or more SRS resources are transmitted.

Clause 35. The UE of clause 34, wherein the at least one processor configured to report comprises the at least one processor configured to: report, via the at least one transceiver, the azimuth angle to the positioning entity in an SRS-azimuth field, and report, via the at least one transceiver, the elevation angle to the positioning entity in an SRS-elevation field.

Clause 36. The UE of any of clauses 34 to 35, wherein: the azimuth angle is reported as a value from 0 to 359.5 degrees with a step size of 0.5 degrees, and the elevation angle is reported as a value from −90 to +90 degrees with a step size of 0.5 degrees.

Clause 37. The UE of any of clauses 33 to 36, wherein the beam pattern comprises: a half-power beam width (HPBW) in a horizontal plane of a beam on which the one or more SRS resources are transmitted, and an HPBW in a vertical plane of the beam on which the one or more SRS resources are transmitted.

Clause 38. The UE of clause 37, wherein the at least one processor configured to report comprises the at least one processor configured to: report, via the at least one transceiver, the HPBW in the horizontal plane to the positioning entity in an SRS-HPBW-Az field, and report, via the at least one transceiver, the HPBW in the vertical plane to the positioning entity in an SRS-HPBW-El field.

Clause 39. The UE of any of clauses 37 to 38, wherein: the HPBW in the horizontal plane is reported as a value from 0 to 120 degrees with a step size of 0.5 degrees, and the HPBW in the vertical plane is reported as a value from 0 to 120 degrees with a step size of 0.5 degrees.

Clause 40. The UE of any of clauses 31 to 39, wherein the orientation of the one or more antennas is reported in a local coordinate system (LCS) of the UE.

Clause 41. The UE of clause 40, wherein the at least one processor configured to report the orientation of the one or more antennas comprises the at least one processor configured to: report, via the at least one transceiver, a bearing angle (α) of the one or more antennas for a translation of the LCS to a global coordinate system (GCS), report, via the at least one transceiver, a downtilt angle (β) of the one or more antennas for the translation of the LCS to the GCS, and report, via the at least one transceiver, a slant angle (γ) of the one or more antennas for the translation of the LCS to the GCS.

Clause 42. The UE of any of clauses 31 to 41, wherein the one or more angle-based measurements, the beam pattern associated with the one or more reference signal resources, the type of the one or more antennas, the locations of the one or more antennas on the UE, the orientation of the one or more antennas, or any combination thereof are reported in: a UE positioning capability report, a request for assistance data, a provide location information message, or any combination thereof.

Clause 43. The UE of any of clauses 31 to 42, wherein the one or more angle-based measurements, the beam pattern associated with the one or more reference signal resources, the type of the one or more antennas, the locations of the one or more antennas on the UE, the orientation of the one or more antennas, or any combination thereof are reported in: uplink control information (UCI), medium access control control element (MAC-CE), radio resource control (RRC) signaling, one or more Long-Term Evolution (LTE) positioning protocol (LPP) messages, or any combination thereof.

Clause 44. The UE of any of clauses 31 to 43, wherein the positioning entity comprises: a location server, a serving base station of the UE, or another UE connected to the UE over a sidelink.

Clause 45. The UE of clause 31, wherein the one or more angle-based measurements comprise a downlink angle of arrival (DL-AoA) measurement.

Clause 46. The UE of clause 45, wherein the one or more reference signal resources comprise one or more positioning reference signals (PRS) resources.

Clause 47. The UE of clause 46, wherein the DL-AoA measurement comprises: an azimuth angle of a boresight direction in which the one or more PRS resources are received, and an elevation angle of the boresight direction in which the one or more PRS resources are received.

Clause 48. The UE of any of clauses 46 to 47, wherein the beam pattern comprises: a half-power beam width (HPBW) in a horizontal plane of a beam on which the one or more PRS resources are received, and an HPBW in a vertical plane of the beam on which the one or more PRS resources are received.

Clause 49. The UE of any of clauses 31 to 48, wherein the beam pattern associated with the one or more reference signal resources and the locations of the one or more antennas are reported in one or more antenna placement and calibration information elements (IEs).

Clause 50. The UE of clause 49, wherein the locations of the one or more antennas comprise x, y, z coordinates of the one or more antennas.

Clause 51. The UE of any of clauses 49 to 50, wherein the beam pattern comprises a value from 1 degree to 360 degrees.

Clause 52. The UE of any of clauses 31 to 51, wherein the at least one processor configured to report comprises the at least one processor configured to: report, via the at least one transceiver, the one or more angle-based measurements, the beam pattern associated with the one or more reference signal resources, the locations of the one or more antennas, the orientation of the one or more antennas, or any combination thereof relative to a reference antenna of the one or more antennas.

Clause 53. The UE of clause 52, wherein: the one or more antennas comprise a plurality of antennas, the one or more angle-based measurements comprise an angle-based measurement associated with each of the plurality of antennas, the beam pattern associated with the one or more reference signal resources comprise a beam pattern associated with each of the plurality of antennas, the locations of the one or more antennas comprise a location of each of the plurality of antennas, and the orientation of the one or more antennas comprises an orientation of each of the one or more antennas.

Clause 54. The UE of clause 53, wherein the at least one processor configured to report comprises the at least one processor configured to: report, via the at least one transceiver, absolute values for the angle-based measurement, the beam pattern, the location, the orientation, or any combination thereof for the reference antenna; and report, via the at least one transceiver, values for the angle-based measurement, the beam pattern, the location, the orientation, or any combination thereof for remaining antennas of the plurality of antennas relative to the absolute values for the reference antenna.

Clause 55. The UE of any of clauses 31 to 54, wherein the type of the one or more antennas comprises an omnidirectional antenna.

Clause 56. The UE of any of clauses 31 to 54, wherein the type of the one or more antennas comprises a directional antenna capable of beamforming.

Clause 57. The UE of any of clauses 31 to 56, wherein the at least one processor is further configured to: transmit, via the at least one transceiver, the one or more reference signal resources on the one or more antennas of the UE.

Clause 58. The UE of any of clauses 31 to 56, wherein the at least one processor is further configured to: receive, via the at least one transceiver, the one or more reference signal resources on the one or more antennas of the UE.

Clause 59. The UE of any of clauses 31 to 58, wherein the beam pattern comprises a beam width associated with the one or more reference signal resources.

Clause 60. The UE of any of clauses 31 to 59, wherein: the UE operates in accordance with a radio access technology (RAT), the one or more reference signal resources are configured according to the RAT, and the RAT comprises: LTE, Fifth Generation New Radio (5G NR), Wi-Fi, ultra-wideband (UWB), or Bluetooth.

Clause 61. A user equipment (UE), comprising: means for determining one or more angle-based measurements of one or more reference signal resources transmitted by or received at the UE on one or more antennas of the UE; and means for reporting, to a positioning entity, the one or more angle-based measurements, a beam pattern associated with the one or more reference signal resources, a type of the one or more antennas, locations of the one or more antennas on the UE, an orientation of the one or more antennas, or any combination thereof.

Clause 62. The UE of clause 61, wherein the one or more angle-based measurements comprise an uplink angle of departure (UL-AoD) measurement.

Clause 63. The UE of clause 62, wherein the one or more reference signal resources comprise one or more sounding reference signals (SRS) resources.

Clause 64. The UE of clause 63, wherein the UL-AoD measurement comprises: an azimuth angle of a boresight direction in which the one or more SRS resources are transmitted, and an elevation angle of the boresight direction in which the one or more SRS resources are transmitted.

Clause 65. The UE of clause 64, wherein the means for reporting comprises: means for reporting the azimuth angle to the positioning entity in an SRS-azimuth field, and means for reporting the elevation angle to the positioning entity in an SRS-elevation field.

Clause 66. The UE of any of clauses 64 to 65, wherein: the azimuth angle is reported as a value from 0 to 359.5 degrees with a step size of 0.5 degrees, and the elevation angle is reported as a value from −90 to +90 degrees with a step size of 0.5 degrees.

Clause 67. The UE of any of clauses 63 to 66, wherein the beam pattern comprises: a half-power beam width (HPBW) in a horizontal plane of a beam on which the one or more SRS resources are transmitted, and an HPBW in a vertical plane of the beam on which the one or more SRS resources are transmitted.

Clause 68. The UE of clause 67, wherein the means for reporting comprises: means for reporting the HPBW in the horizontal plane to the positioning entity in an SRS-HPBW-Az field, and means for reporting the HPBW in the vertical plane to the positioning entity in an SRS-HPBW-El field.

Clause 69. The UE of any of clauses 67 to 68, wherein: the HPBW in the horizontal plane is reported as a value from 0 to 120 degrees with a step size of 0.5 degrees, and the HPBW in the vertical plane is reported as a value from 0 to 120 degrees with a step size of 0.5 degrees.

Clause 70. The UE of any of clauses 61 to 69, wherein the orientation of the one or more antennas is reported in a local coordinate system (LCS) of the UE.

Clause 71. The UE of clause 70, wherein the means for reporting the orientation of the one or more antennas comprises: means for reporting a bearing angle (α) of the one or more antennas for a translation of the LCS to a global coordinate system (GCS), means for reporting a downtilt angle (β) of the one or more antennas for the translation of the LCS to the GCS, and means for reporting a slant angle (γ) of the one or more antennas for the translation of the LCS to the GCS.

Clause 72. The UE of any of clauses 61 to 71, wherein the one or more angle-based measurements, the beam pattern associated with the one or more reference signal resources, the type of the one or more antennas, the locations of the one or more antennas on the UE, the orientation of the one or more antennas, or any combination thereof are reported in: a UE positioning capability report, a request for assistance data, a provide location information message, or any combination thereof.

Clause 73. The UE of any of clauses 61 to 72, wherein the one or more angle-based measurements, the beam pattern associated with the one or more reference signal resources, the type of the one or more antennas, the locations of the one or more antennas on the UE, the orientation of the one or more antennas, or any combination thereof are reported in: uplink control information (UCI), medium access control control element (MAC-CE), radio resource control (RRC) signaling, one or more Long-Term Evolution (LTE) positioning protocol (LPP) messages, or any combination thereof.

Clause 74. The UE of any of clauses 61 to 73, wherein the positioning entity comprises: a location server, a serving base station of the UE, or another UE connected to the UE over a sidelink.

Clause 75. The UE of clause 61, wherein the one or more angle-based measurements comprise a downlink angle of arrival (DL-AoA) measurement.

Clause 76. The UE of clause 75, wherein the one or more reference signal resources comprise one or more positioning reference signals (PRS) resources.

Clause 77. The UE of clause 76, wherein the DL-AoA measurement comprises: an azimuth angle of a boresight direction in which the one or more PRS resources are received, and an elevation angle of the boresight direction in which the one or more PRS resources are received.

Clause 78. The UE of any of clauses 76 to 77, wherein the beam pattern comprises: a half-power beam width (HPBW) in a horizontal plane of a beam on which the one or more PRS resources are received, and an HPBW in a vertical plane of the beam on which the one or more PRS resources are received.

Clause 79. The UE of any of clauses 61 to 78, wherein the beam pattern associated with the one or more reference signal resources and the locations of the one or more antennas are reported in one or more antenna placement and calibration information elements (IEs).

Clause 80. The UE of clause 79, wherein the locations of the one or more antennas comprise x, y, z coordinates of the one or more antennas.

Clause 81. The UE of any of clauses 79 to 80, wherein the beam pattern comprises a value from 1 degree to 360 degrees.

Clause 82. The UE of any of clauses 61 to 81, wherein the means for reporting comprises: means for reporting the one or more angle-based measurements, the beam pattern associated with the one or more reference signal resources, the locations of the one or more antennas, the orientation of the one or more antennas, or any combination thereof relative to a reference antenna of the one or more antennas.

Clause 83. The UE of clause 82, wherein: the one or more antennas comprise a plurality of antennas, the one or more angle-based measurements comprise an angle-based measurement associated with each of the plurality of antennas, the beam pattern associated with the one or more reference signal resources comprise a beam pattern associated with each of the plurality of antennas, the locations of the one or more antennas comprise a location of each of the plurality of antennas, and the orientation of the one or more antennas comprises an orientation of each of the one or more antennas.

Clause 84. The UE of clause 83, wherein the means for reporting comprises: means for reporting absolute values for the angle-based measurement, the beam pattern, the location, the orientation, or any combination thereof for the reference antenna; and means for reporting values for the angle-based measurement, the beam pattern, the location, the orientation, or any combination thereof for remaining antennas of the plurality of antennas relative to the absolute values for the reference antenna.

Clause 85. The UE of any of clauses 61 to 84, wherein the type of the one or more antennas comprises an omnidirectional antenna.

Clause 86. The UE of any of clauses 61 to 84, wherein the type of the one or more antennas comprises a directional antenna capable of beamforming.

Clause 87. The UE of any of clauses 61 to 86, further comprising: means for transmitting the one or more reference signal resources on the one or more antennas of the UE.

Clause 88. The UE of any of clauses 61 to 86, further comprising: means for receiving the one or more reference signal resources on the one or more antennas of the UE.

Clause 89. The UE of any of clauses 61 to 88, wherein the beam pattern comprises a beam width associated with the one or more reference signal resources.

Clause 90. The UE of any of clauses 61 to 89, wherein: the UE operates in accordance with a radio access technology (RAT), the one or more reference signal resources are configured according to the RAT, and the RAT comprises: LTE, Fifth Generation New Radio (5G NR), Wi-Fi, ultra-wideband (UWB), or Bluetooth.

Clause 91. A non-transitory computer-readable medium storing computer-executable instructions that, when executed by a user equipment (UE), cause the UE to: determine one or more angle-based measurements of one or more reference signal resources transmitted by or received at the UE on one or more antennas of the UE; and report, to a positioning entity, the one or more angle-based measurements, a beam pattern associated with the one or more reference signal resources, a type of the one or more antennas, locations of the one or more antennas on the UE, an orientation of the one or more antennas, or any combination thereof.

Clause 92. The non-transitory computer-readable medium of clause 91, wherein the one or more angle-based measurements comprise an uplink angle of departure (UL-AoD) measurement.

Clause 93. The non-transitory computer-readable medium of clause 92, wherein the one or more reference signal resources comprise one or more sounding reference signals (SRS) resources.

Clause 94. The non-transitory computer-readable medium of clause 93, wherein the UL-AoD measurement comprises: an azimuth angle of a boresight direction in which the one or more SRS resources are transmitted, and an elevation angle of the boresight direction in which the one or more SRS resources are transmitted.

Clause 95. The non-transitory computer-readable medium of clause 94, wherein the computer-executable instructions that, when executed by the UE, cause the UE to report comprise computer-executable instructions that, when executed by the UE, cause the UE to: report the azimuth angle to the positioning entity in an SRS-azimuth field, and report the elevation angle to the positioning entity in an SRS-elevation field.

Clause 96. The non-transitory computer-readable medium of any of clauses 94 to 95, wherein: the azimuth angle is reported as a value from 0 to 359.5 degrees with a step size of 0.5 degrees, and the elevation angle is reported as a value from −90 to +90 degrees with a step size of 0.5 degrees.

Clause 97. The non-transitory computer-readable medium of any of clauses 93 to 96, wherein the beam pattern comprises: a half-power beam width (HPBW) in a horizontal plane of a beam on which the one or more SRS resources are transmitted, and an HPBW in a vertical plane of the beam on which the one or more SRS resources are transmitted.

Clause 98. The non-transitory computer-readable medium of clause 97, wherein the computer-executable instructions that, when executed by the UE, cause the UE to report comprise computer-executable instructions that, when executed by the UE, cause the UE to: report the HPBW in the horizontal plane to the positioning entity in an SRS-HPBW-Az field, and report the HPBW in the vertical plane to the positioning entity in an SRS-HPBW-El field.

Clause 99. The non-transitory computer-readable medium of any of clauses 97 to 98, wherein: the HPBW in the horizontal plane is reported as a value from 0 to 120 degrees with a step size of 0.5 degrees, and the HPBW in the vertical plane is reported as a value from 0 to 120 degrees with a step size of 0.5 degrees.

Clause 100. The non-transitory computer-readable medium of any of clauses 91 to 99, wherein the orientation of the one or more antennas is reported in a local coordinate system (LCS) of the UE.

Clause 101. The non-transitory computer-readable medium of clause 100, wherein the computer-executable instructions that, when executed by the UE, cause the UE to report the orientation of the one or more antennas comprise computer-executable instructions that, when executed by the UE, cause the UE to: report a bearing angle (α) of the one or more antennas for a translation of the LCS to a global coordinate system (GCS), report a downtilt angle (β) of the one or more antennas for the translation of the LCS to the GCS, and report a slant angle (γ) of the one or more antennas for the translation of the LCS to the GCS.

Clause 102. The non-transitory computer-readable medium of any of clauses 91 to 101, wherein the one or more angle-based measurements, the beam pattern associated with the one or more reference signal resources, the type of the one or more antennas, the locations of the one or more antennas on the UE, the orientation of the one or more antennas, or any combination thereof are reported in: a UE positioning capability report, a request for assistance data, a provide location information message, or any combination thereof.

Clause 103. The non-transitory computer-readable medium of any of clauses 91 to 102, wherein the one or more angle-based measurements, the beam pattern associated with the one or more reference signal resources, the type of the one or more antennas, the locations of the one or more antennas on the UE, the orientation of the one or more antennas, or any combination thereof are reported in: uplink control information (UCI), medium access control control element (MAC-CE), radio resource control (RRC) signaling, one or more Long-Term Evolution (LTE) positioning protocol (LPP) messages, or any combination thereof.

Clause 104. The non-transitory computer-readable medium of any of clauses 91 to 103, wherein the positioning entity comprises: a location server, a serving base station of the UE, or another UE connected to the UE over a sidelink.

Clause 105. The non-transitory computer-readable medium of clause 91, wherein the one or more angle-based measurements comprise a downlink angle of arrival (DL-AoA) measurement.

Clause 106. The non-transitory computer-readable medium of clause 105, wherein the one or more reference signal resources comprise one or more positioning reference signals (PRS) resources.

Clause 107. The non-transitory computer-readable medium of clause 106, wherein the DL-AoA measurement comprises: an azimuth angle of a boresight direction in which the one or more PRS resources are received, and an elevation angle of the boresight direction in which the one or more PRS resources are received.

Clause 108. The non-transitory computer-readable medium of any of clauses 106 to 107, wherein the beam pattern comprises: a half-power beam width (HPBW) in a horizontal plane of a beam on which the one or more PRS resources are received, and an HPBW in a vertical plane of the beam on which the one or more PRS resources are received.

Clause 109. The non-transitory computer-readable medium of any of clauses 91 to 108, wherein the beam pattern associated with the one or more reference signal resources and the locations of the one or more antennas are reported in one or more antenna placement and calibration information elements (IEs).

Clause 110. The non-transitory computer-readable medium of clause 109, wherein the locations of the one or more antennas comprise x, y, z coordinates of the one or more antennas.

Clause 111. The non-transitory computer-readable medium of any of clauses 109 to 110, wherein the beam pattern comprises a value from 1 degree to 360 degrees.

Clause 112. The non-transitory computer-readable medium of any of clauses 91 to 111, wherein the computer-executable instructions that, when executed by the UE, cause the UE to report comprise computer-executable instructions that, when executed by the UE, cause the UE to: report the one or more angle-based measurements, the beam pattern associated with the one or more reference signal resources, the locations of the one or more antennas, the orientation of the one or more antennas, or any combination thereof relative to a reference antenna of the one or more antennas.

Clause 113. The non-transitory computer-readable medium of clause 112, wherein: the one or more antennas comprise a plurality of antennas, the one or more angle-based measurements comprise an angle-based measurement associated with each of the plurality of antennas, the beam pattern associated with the one or more reference signal resources comprise a beam pattern associated with each of the plurality of antennas, the locations of the one or more antennas comprise a location of each of the plurality of antennas, and the orientation of the one or more antennas comprises an orientation of each of the one or more antennas.

Clause 114. The non-transitory computer-readable medium of clause 113, wherein the computer-executable instructions that, when executed by the UE, cause the UE to report comprise computer-executable instructions that, when executed by the UE, cause the UE to: report absolute values for the angle-based measurement, the beam pattern, the location, the orientation, or any combination thereof for the reference antenna; and report values for the angle-based measurement, the beam pattern, the location, the orientation, or any combination thereof for remaining antennas of the plurality of antennas relative to the absolute values for the reference antenna.

Clause 115. The non-transitory computer-readable medium of any of clauses 91 to 114, wherein the type of the one or more antennas comprises an omnidirectional antenna.

Clause 116. The non-transitory computer-readable medium of any of clauses 91 to 114, wherein the type of the one or more antennas comprises a directional antenna capable of beamforming.

Clause 117. The non-transitory computer-readable medium of any of clauses 91 to 116, further comprising computer-executable instructions that, when executed by the UE, cause the UE to: transmit the one or more reference signal resources on the one or more antennas of the UE.

Clause 118. The non-transitory computer-readable medium of any of clauses 91 to 116, further comprising computer-executable instructions that, when executed by the UE, cause the UE to: receive the one or more reference signal resources on the one or more antennas of the UE.

Clause 119. The non-transitory computer-readable medium of any of clauses 91 to 118, wherein the beam pattern comprises a beam width associated with the one or more reference signal resources.

Clause 120. The non-transitory computer-readable medium of any of clauses 91 to 119, wherein: the UE operates in accordance with a radio access technology (RAT), the one or more reference signal resources are configured according to the RAT, and the RAT comprises: LTE, Fifth Generation New Radio (5G NR), Wi-Fi, ultra-wideband (UWB), or Bluetooth.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication positioning by a user equipment (UE), comprising:
determining one or more angle-based measurements of one or more reference signal resources transmitted by or received at the UE on one or more antennas of the UE; and
reporting, to a positioning entity, the one or more angle-based measurements, a beam pattern associated with the one or more reference signal resources, a type of the one or more antennas, locations of the one or more antennas on the UE, an orientation of the one or more antennas, or any combination thereof.

2. The method of claim 1, wherein the one or more angle-based measurements comprise an uplink angle of departure (UL-AoD) measurement.

3. The method of claim 2, wherein the one or more reference signal resources comprise one or more sounding reference signals (SRS) resources.

4. The method of claim 3, wherein the UL-AoD measurement comprises:
an azimuth angle of a boresight direction in which the one or more SRS resources are transmitted, and
an elevation angle of the boresight direction in which the one or more SRS resources are transmitted.

5. The method of claim 4, wherein the reporting comprises:
reporting the azimuth angle to the positioning entity in an SRS-azimuth field, and
reporting the elevation angle to the positioning entity in an SRS-elevation field.

6. The method of claim 4, wherein:
the azimuth angle is reported as a value from 0 to 359.5 degrees with a step size of 0.5 degrees, and
the elevation angle is reported as a value from −90 to +90 degrees with a step size of 0.5 degrees.

7. The method of claim 3, wherein the beam pattern comprises:
a half-power beam width (HPBW) in a horizontal plane of a beam on which the one or more SRS resources are transmitted, and
an HPBW in a vertical plane of the beam on which the one or more SRS resources are transmitted.

8. The method of claim 7, wherein the reporting comprises:
reporting the HPBW in the horizontal plane to the positioning entity in an SRS-HPBW-Az field, and
reporting the HPBW in the vertical plane to the positioning entity in an SRS-HPBW-El field.

9. The method of claim 7, wherein:
the HPBW in the horizontal plane is reported as a value from 0 to 120 degrees with a step size of 0.5 degrees, and
the HPBW in the vertical plane is reported as a value from 0 to 120 degrees with a step size of 0.5 degrees.

10. The method of claim 1, wherein the orientation of the one or more antennas is reported in a local coordinate system (LCS) of the UE.

11. The method of claim 10, wherein reporting the orientation of the one or more antennas comprises:
reporting a bearing angle (α) of the one or more antennas for a translation of the LCS to a global coordinate system (GCS),
reporting a downtilt angle (β) of the one or more antennas for the translation of the LCS to the GCS, and
reporting a slant angle (γ) of the one or more antennas for the translation of the LCS to the GCS.

12. The method of claim 1, wherein the one or more angle-based measurements, the beam pattern associated with the one or more reference signal resources, the type of the one or more antennas, the locations of the one or more antennas on the UE, the orientation of the one or more antennas, or any combination thereof are reported in:
a UE positioning capability report,
a request for assistance data,
a provide location information message, or
any combination thereof.

13. The method of claim 1, wherein the one or more angle-based measurements, the beam pattern associated with the one or more reference signal resources, the type of the one or more antennas, the locations of the one or more antennas on the UE, the orientation of the one or more antennas, or any combination thereof are reported in:
uplink control information (UCI),
medium access control control element (MAC-CE),
radio resource control (RRC) signaling,
one or more Long-Term Evolution (LTE) positioning protocol (LPP) messages, or
any combination thereof.

14. The method of claim 1, wherein the positioning entity comprises:
a location server,
a serving base station of the UE, or
another UE connected to the UE over a sidelink.

15. The method of claim 1, wherein the one or more angle-based measurements comprise a downlink angle of arrival (DL-AoA) measurement.

16. The method of claim 15, wherein the one or more reference signal resources comprise one or more positioning reference signals (PRS) resources.

17. The method of claim 16, wherein the DL-AoA measurement comprises:
an azimuth angle of a boresight direction in which the one or more PRS resources are received, and
an elevation angle of the boresight direction in which the one or more PRS resources are received.

18. The method of claim 16, wherein the beam pattern comprises:
a half-power beam width (HPBW) in a horizontal plane of a beam on which the one or more PRS resources are received, and
an HPBW in a vertical plane of the beam on which the one or more PRS resources are received.

19. The method of claim 1, wherein the beam pattern associated with the one or more reference signal resources and the locations of the one or more antennas are reported in one or more antenna placement and calibration information elements (IEs).

20. The method of claim 19, wherein the locations of the one or more antennas comprise x, y, z coordinates of the one or more antennas.

21. The method of claim 19, wherein the beam pattern comprises a value from 1 degree to 360 degrees.

22. The method of claim 1, wherein the reporting comprises:
reporting the one or more angle-based measurements, the beam pattern associated with the one or more reference signal resources, the locations of the one or more antennas, the orientation of the one or more antennas, or any combination thereof relative to a reference antenna of the one or more antennas.

23. The method of claim 22, wherein:
the one or more antennas comprise a plurality of antennas,
the one or more angle-based measurements comprise an angle-based measurement associated with each of the plurality of antennas,
the beam pattern associated with the one or more reference signal resources comprise a beam pattern associated with each of the plurality of antennas,
the locations of the one or more antennas comprise a location of each of the plurality of antennas, and
the orientation of the one or more antennas comprises an orientation of each of the one or more antennas.

24. The method of claim 23, wherein the reporting comprises:
reporting absolute values for the angle-based measurement, the beam pattern, the location, the orientation, or any combination thereof for the reference antenna; and
reporting values for the angle-based measurement, the beam pattern, the location, the orientation, or any combination thereof for remaining antennas of the plurality of antennas relative to the absolute values for the reference antenna.

25. The method of claim 1, wherein the type of the one or more antennas comprises an omnidirectional antenna.

26. The method of claim 1, wherein the type of the one or more antennas comprises a directional antenna capable of beamforming.

27. The method of claim 1, further comprising:
transmitting the one or more reference signal resources on the one or more antennas of the UE.

28. The method of claim 1, further comprising:
receiving the one or more reference signal resources on the one or more antennas of the UE.

29. The method of claim 1, wherein the beam pattern comprises a beam width associated with the one or more reference signal resources.

30. The method of claim 1, wherein:
the UE operates in accordance with a radio access technology (RAT),
the one or more reference signal resources are configured according to the RAT, and
the RAT comprises:
LTE,
Fifth Generation New Radio (5G NR),
Wi-Fi,
ultra-wideband (UWB), or
Bluetooth.

31. A user equipment (UE), comprising:
a memory;
at least one transceiver; and
at least one processor communicatively coupled to the memory and the at least one transceiver, the at least one processor configured to:
determine one or more angle-based measurements of one or more reference signal resources transmitted by or received at the UE on one or more antennas of the UE; and
report, via the at least one transceiver, to a positioning entity, the one or more angle-based measurements, a beam pattern associated with the one or more reference signal resources, a type of the one or more antennas, locations of the one or more antennas on the UE, an orientation of the one or more antennas, or any combination thereof.

32. The UE of claim 31, wherein the one or more angle-based measurements comprise an uplink angle of departure (UL-AoD) measurement.

33. The UE of claim 32, wherein the one or more reference signal resources comprise one or more sounding reference signals (SRS) resources.

34. The UE of claim 33, wherein the UL-AoD measurement comprises:
an azimuth angle of a boresight direction in which the one or more SRS resources are transmitted, and
an elevation angle of the boresight direction in which the one or more SRS resources are transmitted.

35. The UE of claim 34, wherein the at least one processor configured to report comprises the at least one processor configured to:
report, via the at least one transceiver, the azimuth angle to the positioning entity in an SRS-azimuth field, and
report, via the at least one transceiver, the elevation angle to the positioning entity in an SRS-elevation field.

36. The UE of claim 34, wherein:
the azimuth angle is reported as a value from 0 to 359.5 degrees with a step size of 0.5 degrees, and
the elevation angle is reported as a value from −90 to +90 degrees with a step size of 0.5 degrees.

37. The UE of claim 33, wherein the beam pattern comprises:
a half-power beam width (HPBW) in a horizontal plane of a beam on which the one or more SRS resources are transmitted, and
an HPBW in a vertical plane of the beam on which the one or more SRS resources are transmitted.

38. The UE of claim 37, wherein the at least one processor configured to report comprises the at least one processor configured to:
report, via the at least one transceiver, the HPBW in the horizontal plane to the positioning entity in an SRS-HPBW-Az field, and
report, via the at least one transceiver, the HPBW in the vertical plane to the positioning entity in an SRS-HPBW-El field.

39. The UE of claim 37, wherein:
the HPBW in the horizontal plane is reported as a value from 0 to 120 degrees with a step size of 0.5 degrees, and
the HPBW in the vertical plane is reported as a value from 0 to 120 degrees with a step size of 0.5 degrees.

40. The UE of claim 31, wherein the orientation of the one or more antennas is reported in a local coordinate system (LCS) of the UE.

41. The UE of claim 40, wherein the at least one processor configured to report the orientation of the one or more antennas comprises the at least one processor configured to:
report, via the at least one transceiver, a bearing angle (α) of the one or more antennas for a translation of the LCS to a global coordinate system (GCS),
report, via the at least one transceiver, a downtilt angle (β) of the one or more antennas for the translation of the LCS to the GCS, and
report, via the at least one transceiver, a slant angle (γ) of the one or more antennas for the translation of the LCS to the GCS.

42. The UE of claim 31, wherein the one or more angle-based measurements comprise a downlink angle of arrival (DL-AoA) measurement.

43. The UE of claim 42, wherein the one or more reference signal resources comprise one or more positioning reference signals (PRS) resources.

44. The UE of claim 43, wherein the DL-AoA measurement comprises:
an azimuth angle of a boresight direction in which the one or more PRS resources are received, and
an elevation angle of the boresight direction in which the one or more PRS resources are received.

45. The UE of claim 43, wherein the beam pattern comprises:
a half-power beam width (HPBW) in a horizontal plane of a beam on which the one or more PRS resources are received, and
an HPBW in a vertical plane of the beam on which the one or more PRS resources are received.

46. The UE of claim 31, wherein the at least one processor configured to report comprises the at least one processor configured to:
report, via the at least one transceiver, the one or more angle-based measurements, the beam pattern associated with the one or more reference signal resources, the locations of the one or more antennas, the orientation of the one or more antennas, or any combination thereof relative to a reference antenna of the one or more antennas.

47. The UE of claim 46, wherein:
the one or more antennas comprise a plurality of antennas,
the one or more angle-based measurements comprise an angle-based measurement associated with each of the plurality of antennas,
the beam pattern associated with the one or more reference signal resources comprise a beam pattern associated with each of the plurality of antennas, the locations of the one or more antennas comprise a location of each of the plurality of antennas, and
the orientation of the one or more antennas comprises an orientation of each of the one or more antennas.

48. The UE of claim 47, wherein the at least one processor configured to report comprises the at least one processor configured to:
report, via the at least one transceiver, absolute values for the angle-based measurement, the beam pattern, the location, the orientation, or any combination thereof for the reference antenna; and
report, via the at least one transceiver, values for the angle-based measurement, the beam pattern, the location, the orientation, or any combination thereof for remaining antennas of the plurality of antennas relative to the absolute values for the reference antenna.

49. A user equipment (UE), comprising:
means for determining one or more angle-based measurements of one or more reference signal resources transmitted by or received at the UE on one or more antennas of the UE; and
means for reporting, to a positioning entity, the one or more angle-based measurements, a beam pattern associated with the one or more reference signal resources, a type of the one or more antennas, locations of the one or more antennas on the UE, an orientation of the one or more antennas, or any combination thereof.
